(19) United States
(12) Patent Application Publication
(10) Pub. No.: US 2014/0166576 A1
(43) Pub. Date: Jun. 19, 2014

(54) SYSTEM FOR AND METHOD OF SEPARATING OIL AND PARTICLES FROM PRODUCED WATER OR FRACTURING WATER

(71) Applicant: Oreco A/S, Vaerlose (DK)

(72) Inventors: Thomas Eilkaer HANSEN, Calgary (CA); Steen LINDSTROM-LANG, Bagsvaerd (DK); Soren Marker FRISENBORG, Kobenhavn NV (DK); Thomas JENSEN, Naerum (DK); Rami ALHAMALAWI, Hedehusene (DK); Kenneth Stegmann JAKOBSEN, Frederiksberg (DK); Jens Husted KJAER, Calgary (CA)

(73) Assignee: Oreco A/S, Vaerlose (DK)

(21) Appl. No.: 14/133,400

(22) Filed: Dec. 18, 2013

(30) Foreign Application Priority Data
Dec. 18, 2012 (CA) 2799017
Feb. 15, 2013 (DK) PA201370086

(51) Int. Cl. C02F 9/00; B01D 21/26; C02F 1/38; B01D 17/02; C02F 1/44; B01D 71/02

(52) U.S. Cl. CPC C02F 9/00; C02F 1/44; B01D 71/02; C02F 1/38; B01D 17/0217; B01D 21/267
USPC 210/636; 210/195.2; 210/141

(57) ABSTRACT

A system of separating oil and water from produced or fracturing water with an intended separation direction, the system includes: a unit for feeding the produced or fracturing water to a solid-fluid separator; a membrane system configured to output clean water; and a decanter configured to output solids, wherein the decanter or the membrane system is coupled to an output of the solid-fluid separator; wherein the membrane system or the decanter is configured to feed remaining fluid from the membrane system or decanter to an oil extractor system configured to output oil; and wherein the oil extractor system comprises a high speed separator configured to output the oil, and has a feedback conduit for feeding a remaining water containing fluid back to the membrane system.

### RELATED APPLICATION DATA

This application claims priority to and the benefit of Canadian Patent Application No. CA 2799017, filed on Dec. 18, 2012, pending, and Danish Patent Application No. DK PA 2013 70086, filed on Feb. 15, 2013, pending. The entire disclosures of both of the above applications are expressly incorporated by reference herein.

### FIELD

This disclosure relates to systems and method of separating oil and particles from produced water or fracturing water. In particular, an embodiment described herein relates to maintaining an operational membrane system during operation of a separation system.

### BACKGROUND

Produced water is water that surfaces together with oil or gas in an oil or gas well, hence the term produced.

Fracking is the process where water with chemicals and sand is pumped into a hydrocarbon containing formation in order to create fractures from where oil and gas can be produced.

The method is gaining increasing popularity, but is mainly used in tight reservoirs or shale formation.

For water that surfaces after a fracking operation, the specific term is frac flow-back water or fracturing water.

The amount of water pumped into the underground is site specific, of which 5%-30% or even 5% to 70% comes back as flow-back water. Flow-back water constitutes huge volumes, and therefore has a big natural impact if not treated or disposed of in a well. Typical flow-back water composition is shown in the below table.

| Content: | Value: |
|---|---|
| Water | 90% |
| Proppant (silica sand) | 9.5% |
| Chemicals | 0.5% |
| Total Suspended Solids (TSS) | 1000 mg/L-7000 mg/L |
| Total Dissolved Solids (TDS) | 30,000 mg/L-180,000 mg/L |
| Total Organic Carbon (TOC) | 30 mg/L-40 mg/L |
| Oil & Grease | 20 mg/L-100 mg/L |
| Volume pr. Frac | 2200 m³-8000 m³ |

Patent GB 1456304 discloses a process and a system for treating an oil-water emulsion such as produced or fracturing water. The first step is to reduce the solids in the water by use of a settling tank. The liquid fraction is then introduced into a membrane system. The retentate is led to an oil separator that separates oil from a residual fraction which is recycled to the membrane system.

From the patent DE 10102700 A1 it known that flushing the membrane system will prolong the life of the membrane system, and flushing the membrane system with pulses is also know from the patent application US 2005/0082224.

It is an object to overcome deficiencies of known systems and methods and/or to provide alternative systems and methods.

### SUMMARY

An embodiment described herein improves overall performances of a separation system, and/or improves, maintains or reduces decrease in efficiency over time of a membrane system in the separation system.

An embodiment described herein addresses problems in operation of separation systems include fouling and possible irreversible fouling of the membrane. An object is to avoid or reduce fouling thereby maintaining or avoiding or postponing decline in the efficiency loss of the membrane.

An embodiment described herein addresses problematic issues in operational separation of oil and water from produced or fracturing water, wherein some issues or challenges include mineral, such as silica, precipitation in the porous matrix of the membrane. This may be in Enhanced Oil Recovery (EOR) applications.

An embodiment described herein addresses irreversible fouling by naphthenic and other petroleum acids.

An embodiment described herein addresses pore blocking of membranes by asphaltenes.

An objective is achieved by a system of separating oil and water from produced or fracturing water with an intended separation direction, the system comprising a solid-fluid separator such as a hydro cyclone followed by a membrane system configured to output clean water and to feed remaining fluid to a an oil extractor system configured to output oil.

By fracturing water may be understood as any fracturing fluids.

In particular a system wherein the membrane system is further configured with a flushing system and preferably a backward flush system is advantageous.

A further advantageous system may be achieved when the backward flush system is further configured to flush or back-flush with a flushing agent.

According to an embodiment the flushing and preferably the backward flush system may further be configured to flush with pulses and preferably back-flush with back-pulses.

In an embodiment the membrane system is a ceramic membrane system.

Such system may be configured in a variety of implementations and the person skilled in the art will be able to choose several starting points.

One such starting point of a system may be a system configured with a unit for feeding the produced or fracturing water to a solid-fluid separator such as a hydro cyclone followed by a membrane system configured to output clean water and feed a remaining fluid to a decanter configured to output solids and to feed a remaining fluid to a high speed separator configured to output oil and with a feedback conduit for feeding a remaining water containing fluid back to the membrane system.

Another such starting point of a system may be a system configured with a unit for feeding the produced or fracturing water to a solid-fluid separator such as a hydro cyclone followed by a decanter with an output to solids and a feed of a liquid fraction to a membrane system configured to output clean water and feed remaining fluid to a high speed separator configured to output oil and with a feedback conduit for feeding a remaining water containing fluid back to the membrane system.

Yet another such starting point of a system may be a system configured with a unit for feeding the produced or fracturing water to a solid-fluid separator such as a hydro cyclone followed by a membrane system configured to output clean water and feed remaining fluid to centrifuge, preferably a nozzle centrifuge, configured to output oil and with a feedback conduit for feeding a remaining water containing fluid back to the membrane system.

All of those disclosed systems may have the membrane system further configured to be flushed by a back flushing system using a flushing agent, and in which the back flushing system comprises a back flush pump configured to provide pressure, preferably in connection with a pressure vessel a back flush valve configured to regulate the provided pressure in the membrane system for a given period of time, and a permeate valve configured to equalise pressure in the membrane system.

According to an embodiment, the flushing system and/or the backward flushing system may be configured to produce a flushing sequence with pulses of variable pressures, variable pulse width and/or variable pulse period.

The effects of these system elements are understood as they are or in the context of using the systems. Furthermore an object is achieved by a method of separating oil and water from produced or fracturing water comprising at least the steps of feeding through produced or fracturing water to a mechanical separation system comprising a solid-fluid separator with a membrane system configured to process the produced water in an intended separation direction; and which membrane system is configured with a back flush system. The method comprises a step of separating oil to an oil conduit and water to a water conduit. The method comprises a step of back flushing the membrane system with a back flushing fluid using water from the water conduit. For continuous operation the step of back flushing is performed periodically.

The back flushing results in cleaning the membrane to maintain performance over time and thereby providing a more efficient method than without back flushing.

The cleaning may be of particles, chemicals, grease, grown organic organism or any other impurity or combinations thereof.

One particular issue observed is membrane fouling during filtration. It is a common phenomenon that heavily influence membrane performance due to the impact on the permeate flux and trans-membrane pressure.

Back flushing has been observed to maintain a high performance of the membranes and back flushing has in some cases been found to be essential for the process of separating oil and water to function since fouling otherwise would make the separation process impossible, work with difficulties, or with lower than feasible efficiencies.

In order to maintain the high performance of the membranes back flushing is a process where the flow occurs from the permeate side through the membrane and lifts dirt and deposits off membrane surface lasting seconds or minutes.

The liquid or fluid forced through the membrane can be permeate, clean water or water with addition of miscellaneous chemicals.

Typically the produced water contains particles ranging from 100 nm to 500 micron. Those particles can negatively impact the functioning of membranes and back flushing will help clean the membranes from those particles.

A separation system will typically be designed for flows between 5 m3/h to 200 m3/h. The pressure of the fluid through the system will not exceed 6 bar (90 psi). Thus this embodiment relates to separation systems of this capacity although a person skilled in the art will not be limited to such capacities.

In one or more embodiments each step of back flushing is performed using at least one back pulse; preferably a series of 5 to 20 back pulses.

Back pulsing or pulses of back flushing is defined as a back flush for a very short time (seconds or milliseconds), typically at frequent intervals.

Pulses are simply a very short back flush and created by a fast acting valve and a pump, a pressurized vessel or a piston

In one or more embodiments, the use of a “block” or a square pulse on the permeate side is advantageous. Such square pulse can be obtained by building up the pressure and then release it with a quick-release mechanism or by activating the piston.

Such square pulses may be more efficient, as it will loosen the fouling material over the entire surface, as opposed to smoother pulses, which will only loosen the easiest removable fouling material.

A person skilled in the art will appreciate that more frequent back pulses may be preferable over long lasting back pulses, as it is the initial impact from the pulse which is the most efficient part of the pulse.

In one or more embodiments each back pulse may be performed between 1 ms and 10 s; preferably between 100 ms and 1 s.

The pressure amplitude shall be between 0.5 bar and the system maximum allowable pressure. The amplitude is achieved by either increasing permeate pressure or by decreasing the retentate pressure or by doing both simultaneously.

The widths described above may be found experimentally using a few iterations. A person skilled in the art will appreciate that the widths will vary and may depend on the feed.

In general, it is advantageous to keep the pulses as short as possible in order to avoid excessive loss of production time and/or clean water.

One strategy may be to start with a short pulse width. If it works, then a pulse width half the width may be tried, and so repeated until a diminishing effect is reached.

If the starting width does not work, then a pulse width double the starting width may be tried, and so repeated until an effect is reached.

When either of the above widths is determined, interpolating the interval between the two widths may be used to find an optimum width.

In one or more embodiments each back flush is performed within a period of time; preferably between every 1 min to 10 min; most preferably between every 3 to 5 min. This may be per membrane loop or per housing comprising a membrane

In a similar fashion to finding a pulse width, a flushing interval or period may be found.

A person skilled in the art will find it natural to experiment to find an optimal overall efficiency and include parameters such as water used, efficiency of membrane, energy used and time required to obtain or maintain a level.

In one or more embodiments, the pulse width and pulse period is changed or controlled dynamically. In a further embodiment the width and period parameters are used as control parameters to control for a predetermined efficiency as a set point.

In one or more embodiments the method further comprises a step of adding a flushing agent to the back flushing fluid and thus flushing with a fluid containing a flushing agent.

Thereby further enhancing the effect of the back flushing. Hence the back flush will work both mechanically by loosening the foulants, and chemically by dissolving them.

Generally, however, it is not desirable to add an agent since an agent may cause precipitation of salts or other substances in the system.

An agent will also induce an additional operating cost, so operators are generally reluctant to frequently introduce chemicals into the system.

However, it has been found that a particular flushing agent is suitable in systems or methods of separating produced or fracturing water as disclosed. One such flushing agent comprises no more than a total of 100% of:
between 5 to 70% w/w Sodium Carbonate;
between 1 to 20% w/w Disodium Metasilicate;
between 1 to 20% w/w Sodium Percarbonate;
between 1 to 20% w/w Sodium Silicate;
between 0.1 to 15% w/w of a Fatty Alcohol Alkoxylate;

preferably
between about 25 to 60% w/w Sodium Carbonate;
between 4 to 15% w/w Disodium Metasilicate;
between 4 to 15% w/w Sodium Percarbonate;
between 4 to 15% w/w Sodium silicate;
between 1 to 10% w/w of a Fatty Alcohol Alkoxylate.

An alternative flushing agent comprises no more than a total of 100% of:
between 0.1 to 10% w/w Sodium Silicate preferably premixed with between
0.1 to 10% w/w Non-ionic surfactant and mixed with:
between 1 to 20% w/w Sodium percarbonate;
between 5 to 40% w/w Sodium silicate;
between 5 to 40% w/w Sodium carbonate; and

preferably
between 1 to 5% w/w Sodium Silicate preferably premixed with between 1 to 5% w/w Non-ionic surfactant and mixed with:
between 5 to 15% w/w Sodium percarbonate;
between 15 to 30% w/w Sodium silicate;
between 15 to 30% w/w Sodium carbonate.

Yet another alternative flushing agent flushing agent comprises no more than a total of 100% w/w of:
between 0.1 to 20% w/w Citric acid;
between 0.1 to 10% w/w Glycolic acid;
between 1 to 20% w/w Lactic acid;
between 0.1% w/w to 10% w/w Surfactant;

preferably
between 5% w/w to 15% w/w Citric acid;
between 1% w/w to 5% w/w Glycolic acid;
between 5% w/w to 15% w/w Lactic acid;
between 1% w/w to 5% w/w Surfactant;

Circulating a flushing agent in the system for no less than 20 s up to, but not limited to 120 min may be required to achieve the effect depending on the fracturing or produced water, the mixtures of the flushing agents and the dilutions.

In one or more embodiments, the solution with the flushing agent may be circulated in the system 1-120 min at elevated temperatures. A subsequent water flush will remove the solution from the system.

In alternative embodiments adding an acid to the flushing procedure may make the flushing further advantageous. A citric acid may be used.

An objective may be achieved by an exemplary method of separating oil and water from produced or fracturing water using a water-oil separation system configured with unit for feeding the produced water to a solid-fluid separator such as a hydro cyclone followed by a membrane system configured to output clean water and feed a remaining fluid to a decanter configured to output solids and to feed a remaining fluid to a high speed separator configured to output oil and with a feedback conduit for feeding a remaining water containing fluid back to the membrane system, which membrane system further is configured to be flushed by a back flushing system using a flushing agent.

In such configuration using a flushing agent comprising no more than a total of 100% of:
between 0.1 to 10% w/w Sodium Silicate preferably premixed with;
between 0.1 to 10% w/w Non-ionic surfactant and mixed with
between 1 to 20% w/w Sodium percarbonate;
between 5 to 40% w/w Sodium silicate;
between 5 to 40% w/w Sodium carbonate; and
a carrier such as water as required;

preferably
between 1 to 5% w/w Sodium Silicate preferably premixed with;
between 1 to 5% w/w Non-ionic surfactant and mixed with
between 5 to 15% w/w Sodium percarbonate;
between 15 to 30% w/w Sodium silicate;
between 15 to 30% w/w Sodium carbonate; and
a carrier such as water as required.

An objective may be achieved by an exemplary method of separating oil and water from produced or fracturing water using a water-oil separation system configured with a unit for feeding the oil rich fluid to a solid-fluid separator such as a hydro cyclone followed by a decanter with an output to solids and a feed of a liquid fraction to a membrane system configured to output clean water and feed remaining fluid to a high speed separator configured to output oil and with a feedback conduit for feeding a remaining water contending fluid back to the membrane system and which membrane system further is configured to be flushed by a back flushing system using a flushing agent.

In such configuration using a flushing agent comprising no more than a total of 100% of:
between 0.1 to 10% w/w Sodium Silicate preferably premixed with;
between 0.1 to 10% w/w Non-ionic surfactant and mixed with
between 1 to 20% w/w Sodium percarbonate;
between 5 to 40% w/w Sodium silicate;
between 5 to 40% w/w Sodium carbonate; and
a carrier such as water as required;

preferably
between 1 to 5% w/w Sodium Silicate preferably premixed with
between 1 to 5% w/w Non-ionic surfactant and mixed with;
between 5 to 15% w/w Sodium percarbonate;
between 15 to 30% w/w Sodium silicate;
between 15 to 30% w/w Sodium carbonate; and
a carrier such as water as required.

An objective may be achieved by an exemplary method separating oil and water from produced or fracturing water using a water-oil separation system configured with means for feeding the oil rich fluid to a solid-fluid separator such as a hydro cyclone followed by a membrane system configured to output clean water and feed remaining fluid to a nozzle centrifuge configured to output oil and with a feedback conduit for feeding a remaining water contending fluid back to the membrane system; and which membrane system further is configured to be flushed by a back flushing system using a flushing agent.

In such configuration using a flushing agent comprising no more than a total of 100% of:
between 0.1 to 10% w/w Sodium Silicate preferably premixed with
between 0.1 to 10% w/w Non-ionic surfactant and mixed with;
between 1 to 20% w/w Sodium percarbonate;
between 5 to 40% w/w Sodium silicate;
between 5 to 40% w/w Sodium carbonate; and
a carrier such as water as required;

preferably
between 1 to 5% w/w Sodium Silicate preferably premixed with
between 1 to 5% w/w Non-ionic surfactant and mixed with
between 5 to 15% w/w Sodium percarbonate;
between 15 to 30% w/w Sodium silicate;
between 15 to 30% w/w Sodium carbonate; and

a carrier such as water as required.

This method and system would be suitable for produced water, where the system needs to be compact; the oil has an API degree over 10 and does not contain large amounts of solid, e.g. less than 1000 mg/L. This could for example be separation of produced water from a conventional well situated far from ordinary oil/gas infrastructure, which therefore has the need for onsite treatment of the water.

An objective may be achieved by a method of separating oil and water from produced or fracturing water wherein performing at least one back flush of the module using a 0.1% w/w to 10% w/w solution of a flushing agent comprising no more than a total of 100% of:
between 0.1 to 20% w/w Citric acid;
between 0.1 to 10% w/w Glycolic acid;
between 1 to 20% w/w Lactic acid;
between 0.1% w/w to 10% w/w Surfactant;
and a carrier such as water as required;

preferably
between 5% w/w to 15% w/w Citric acid;
between 1% w/w to 5% w/w Glycolic acid;
between 5% w/w to 15% w/w Lactic acid;
between 1% w/w to 5% w/w Surfactant;
and a carrier such as water as required;

Thereby is provided an alternative separation, albeit less effective separation than those previously disclosed.

It is noted that the solid-liquid separator might be preceded by an oxidation step, where ions in the feed liquid will be oxidized in order to form particles which subsequently will be removed by the solid-liquid separator. The ions may be Fe²⁺ or Fe³⁺ oxidized into Fe(OH)₂ or other.

An object is further achieved by a method of restarting a system configured for separating oil and water from produced or fracturing water as disclosed and having a clogged membrane; the method comprising performing at least one back flush of the module using a method as disclosed.

It is understood that the restarting can be done either with a flushing system permanently attached or by attaching a flushing system as disclosed and then performing a back flush as described.

A person skilled in the art will appreciate that conduits between the units need to be applied as needed. Moreover a person skilled in the art will appreciate that additional conduits may be needed to balance the intended flows in the system. Likewise a person skilled in the art will appreciate when there is a need to add buffer tanks to the system.

The embodiments will now be described more fully hereinafter with reference to the accompanying drawings, in which exemplary embodiments are shown. The claimed invention may, however, be embodied in different forms and should not be construed as limited to the embodiments set forth herein. Like reference numerals refer to like elements throughout. Like elements will, thus, not be described in detail with respect to the description of each figure.

A system of separating oil and water from produced or fracturing water with an intended separation direction, the system includes: a unit for feeding the produced or fracturing water to a solid-fluid separator; a membrane system configured to output clean water; and a decanter configured to output solids, wherein the decanter or the membrane system is coupled to an output of the solid-fluid separator; wherein the membrane system or the decanter is configured to feed remaining fluid from the membrane system or decanter to an oil extractor system configured to output oil; and wherein the oil extractor system comprises a high speed separator configured to output the oil, and has a feedback conduit for feeding a remaining water containing fluid back to the membrane system.

Optionally, the membrane system is coupled to a flushing system or a backward flush system.

Optionally, the flushing system or the backward flush system is configured to flush or back-flush with a flushing agent.

Optionally, the flushing or the backward flush system is configured to flush with pulses, or back-flush with back-pulses.

Optionally, the membrane system is a ceramic membrane system.

Optionally, the solid-fluid separator comprises a hydro cyclone.

Optionally, the decanter is configured to feed a liquid fraction to the membrane system.

Optionally, the membrane system, not the decanter, is configured to feed the remaining fluid to the oil extractor system, and wherein the oil extractor system comprises a centrifuge configured to output the oil.

Optionally, the membrane system is configured to be flushed by a back flushing system using a flushing agent, wherein the back flushing system comprises: a back flush pump configured to provide pressure; a back flush valve configured to regulate the provided pressure in the membrane system for a given period of time; and a permeate valve configured to equalise pressure in the membrane system.

Optionally, the system further includes a flushing controller configured to operate the backward flushing system periodically using a flushing sequence.

Optionally, the backward flushing system is configured to produce a flushing sequence with pulses of variable pressures, variable pulse width, and/or variable pulse period.

A method of separating oil and water from produced or fracturing water includes: providing a system comprising: a unit for feeding the produced or fracturing water to a solid-fluid separator; a membrane system configured to output clean water; and a decanter configured to output solids, wherein the decanter or the membrane system is coupled to an output of the solid-fluid separator; wherein the membrane system or the decanter is configured to feed remaining fluid from the membrane system or decanter to an oil extractor system configured to output oil; wherein the oil extractor system comprises a high speed separator configured to output the oil, and has a feedback conduit for feeding a remaining water containing fluid back to the membrane system; and wherein the membrane system is coupled to a flushing system or a backward flush system; and using the system to separate oil and water from the produced or fracturing water.

Optionally, the method further includes periodically flushing or back flushing the membrane system using the flushing system or the backward flush system.

Optionally, the act of periodically flushing or back flushing is performed using pulses or back pulses.

Optionally, each of the pulses or each of the back pulses is performed between 1 ms and 10 s.

Optionally, each of the pulses or each of the back pulses is performed every 1 min to 10 min.

Optionally, the flushing system or the backward flush system uses flushing fluid, and the method further comprises adding a flushing agent to the flushing fluid.

Optionally, the flushing agent comprises no more than a total of 100% of: between 5 to 70% w/w Sodium Carbonate; between 1 to 20% w/w Disodium Metasilicate; between 1 to 20% w/w Sodium Percarbonate; between 1 to 20% w/w Sodium Silicate; and between 0.1 to 15% w/w of a Fatty Alcohol Alkoxylate.

Optionally, the flushing agent comprises no more than a total of 100% of: between 0.1 to 20% w/w Citric acid; between 0.1 to 10% w/w Glycolic acid; between 1 to 20% w/w Lactic acid; and between 0.1% w/w to 10% w/w Surfactant.

Optionally, the flushing agent comprises no more than a total of 100% of between 0.1 to 10% w/w Sodium Silicate and mixed with: between 1 to 20% w/w Sodium percarbonate; between 5 to 40% w/w Sodium silicate; and between 5 to 40% w/w Sodium carbonate.

Optionally, the method further includes circulating the flushing agent in the system for no less than 20 s.

Optionally, the method further includes restarting the system when the membrane system is clogged.

Other and further aspects and features will be evident from reading the following detailed description.

### BRIEF DESCRIPTION OF DRAWINGS

The drawings illustrate the design and utility of embodiments, in which similar elements are referred to by common reference numerals. These drawings may or may not be drawn to scale. In order to better appreciate how the above-recited and other advantages and objects are obtained, a more particular description of the embodiments will be rendered, which are illustrated in the accompanying drawings. These drawings depict only exemplary embodiments and are not therefore to be considered limiting in the scope of the claims.

FIG. 1 illustrates a first embodiment of an oil-water separation system;

FIG. 2 illustrates a second embodiment of an oil-water separation system;

FIG. 3 illustrates a third embodiment of an oil-water separation system;

FIG. 4 illustrates pressures of back pulses and shapes of back pulses

FIG. 5 illustrates an implementation of a procedure for performing a back flush; and

FIG. 6 illustrates the effect on the flux through a membrane system using different kinds of back flushing.

### DETAILED DESCRIPTION

| | |
|---|---|
| 1 | Water-Oil Separation system |
| 2 | Water |
| 3 | Oil |
| 4 | Produced or fracturing water |
| 5 | Oil field |
| 6 | Solids |
| 8 | Oil extractor system |
| 10 | Solid-fluid separator |
| 12 | Decanter |
| 14 | High Speed separator |
| 16 | Membrane system |
| 18 | Membranes |
| 19 | Nozzle centrifuge |
| 20 | Separation direction |
| 22 | Backward direction |
| 30 | Flushing System |
| 32 | Flush Agent |
| 34 | Backward Flush System |
| 40 | Back Pulses |
| 42 | Pulse width |
| 44 | Pulse period |
| 50 | Back flushing |
| 52 | Permeate valve |
| 54 | Back flush pump |
| 56 | Bypass valve |
| 58 | Back flush valve |

Various embodiments are described hereinafter with reference to the figures. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

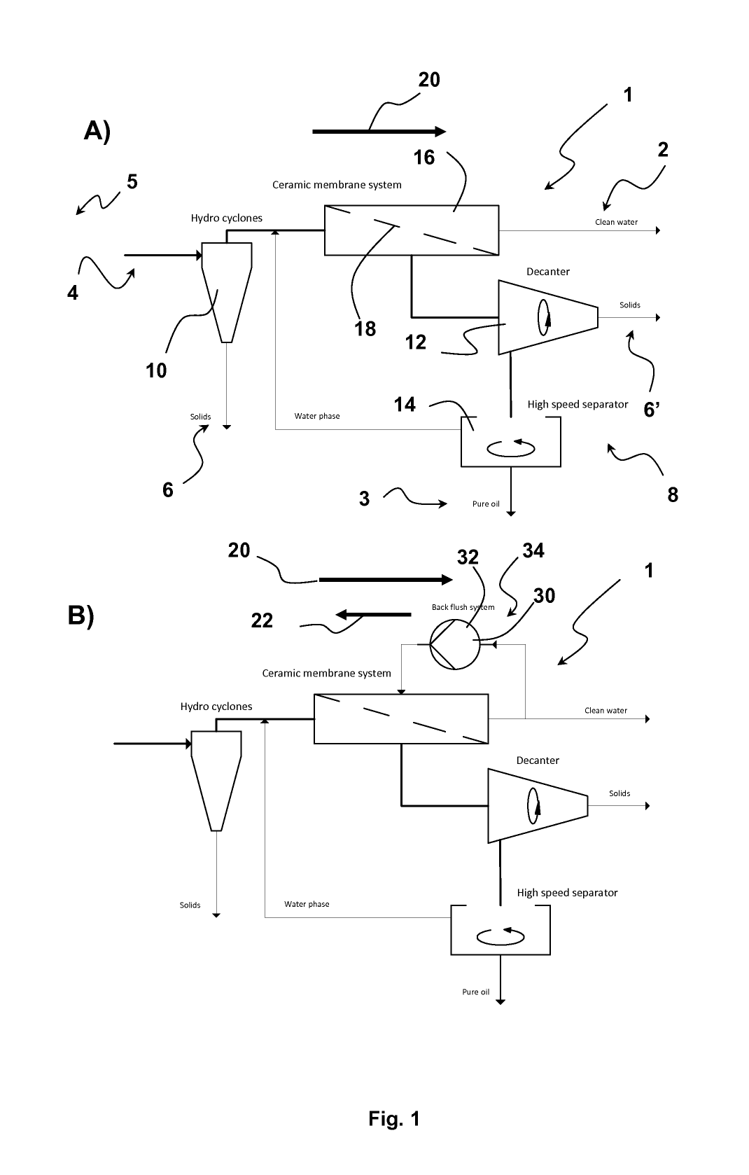

FIG. 1 to FIG. 3 depict individual configurations or embodiments of water-oil separation systems 1 configured to separate water 2 and oil 3 from an oil water fluid such as produced (or frac) water 4 most likely from an oil field 5. The produced water 4 may contain solids 6 of varying sizes.

The water-oil systems 1 depicted have several elements or subsystems in common. Those elements include a solid-fluid separator 10 which may be a hydro cyclone or any equivalent and configured to separate solids 6 from the produced water 4, a decanter 12 configured to further separate solid fractions 6′ in the process, a high speed separator 14 configured to extract oil 3 and preferably purified oil 3.

The water-oil systems 1 further have a membrane system that may be a membrane system 16 configured with membranes 18 to extract water 2 and preferably clean water.

Each system has an intended direction of separation 20 and each unit or subsystem is configured to be coupled each with an intended direction of separation 20. Each system or sub system has an opposite flow direction to the direction of separation, i.e. a backward direction 22.

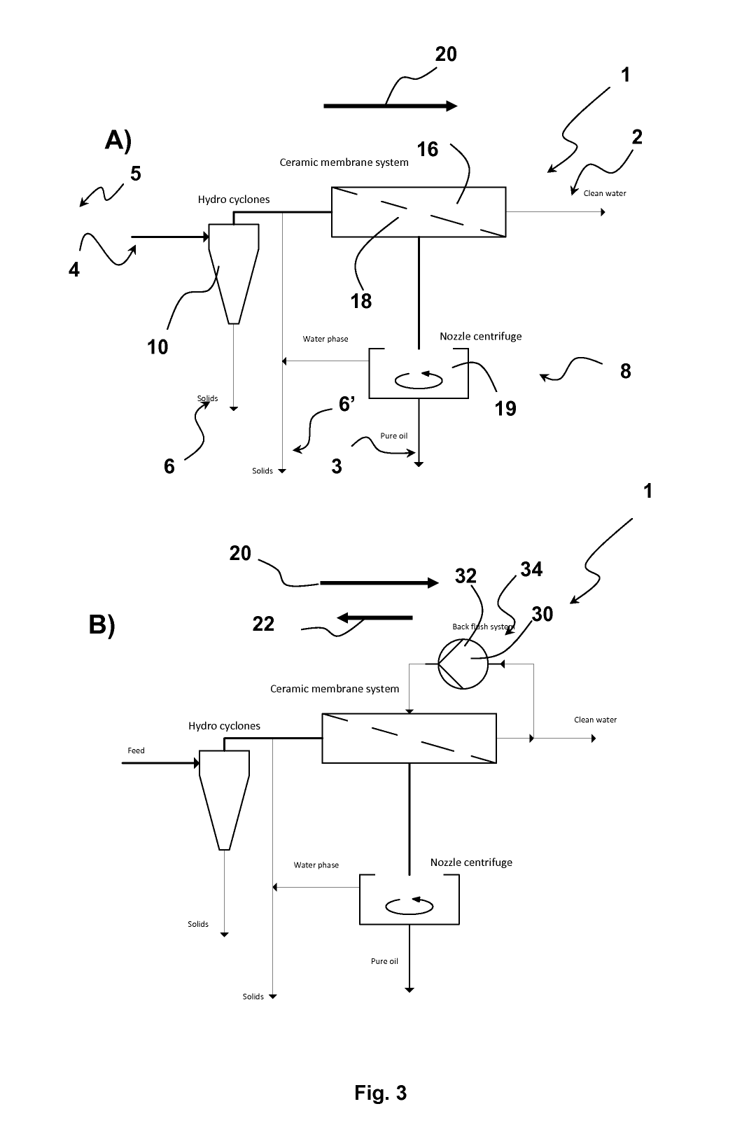

In an embodiment it may be desirable to use a nozzle centrifuge 19 rather than high speed separator 14. This illustrated in FIG. 3.

The illustrated embodiments in FIGS. 1, 2, and 3 all have an additional embodiment with a flushing system 30 configured to flush the water-oil system 1 and as specifically illustrated configured to flush the membrane system 16 and thus the membranes 18 with a flush agent 32. In particular the embodiments illustrate the flushing systems 30 configured as a back flushing systems 34.

FIG. 1a illustrates a water-oil separation system 1 configured with unit for feeding the produced water 4 to a solid-fluid separator 10 such as a hydro cyclone followed by a membrane system 16 configured to output clean water 2 and feed a remaining fluid to a decanter 12 configured to output solids 6 and to feed a remaining fluid to a high speed separator 14 that is configured to output oil 5 and with a feedback conduit for feeding a remaining water containing fluid back to the membrane system 16.

FIG. 1b illustrates an embodiment as in FIG. 1a where the membrane system 16 further is configured to be flushed by a back flushing system 34 using a flushing agent 32.

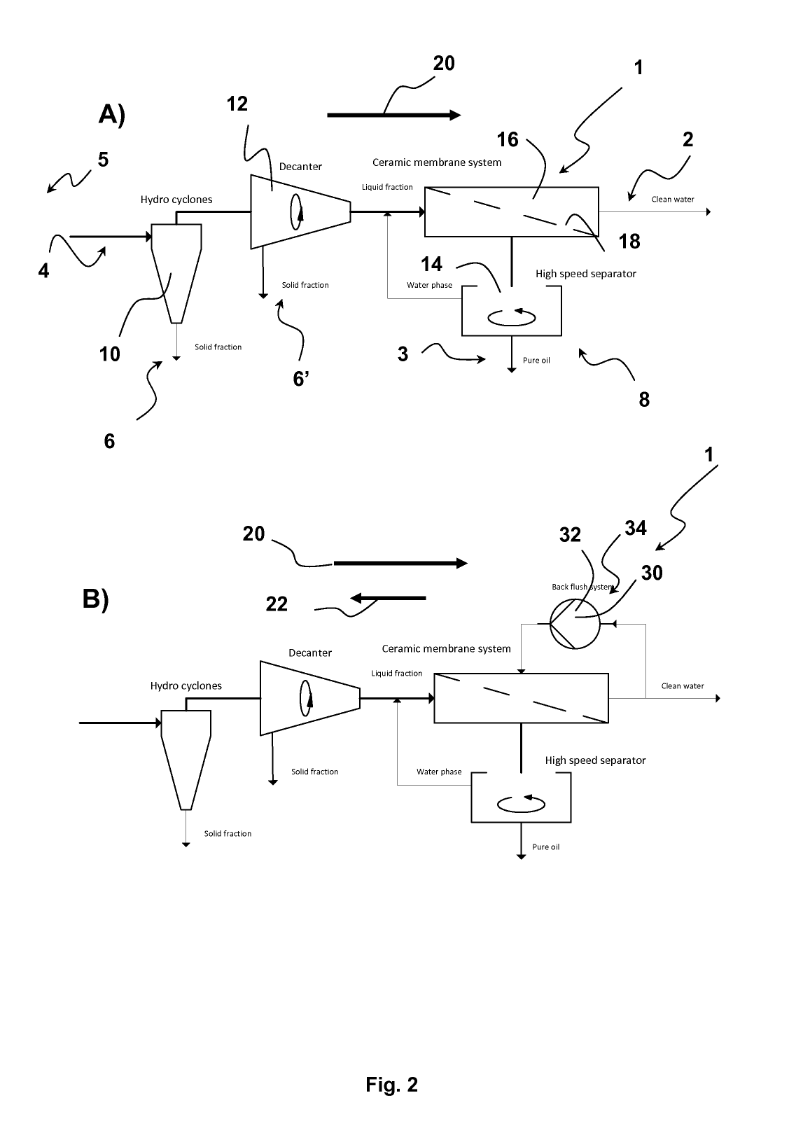

FIG. 2a illustrates a water-oil separation system 1 configured with a unit for feeding produced water 4 to a solid-fluid separator 10 such as a hydro cyclone followed by a decanter 12 with an output of solids 6 and a feed of a liquid fraction to a membrane system 16 configured to output clean water 2 and feed remaining fluid to a high speed separator 14 configured to output oil 3 and with a feedback conduit for feeding a remaining water contending fluid back to the membrane system 14.

FIG. 2b illustrates an embodiment as in FIG. 2a where the membrane system 16 further is configured to be flushed by a back flushing system 34 using a flushing agent 32.

FIG. 3a illustrates a water-oil separation system 1 configured with means for feeding the produced water 4 to a solid-fluid separator 19 such as a hydro cyclone followed by a membrane system 16 configured to output clean water 2 and feed remaining fluid to a nozzle centrifuge 19 configured to output oil 3 and with a feedback conduit for feeding a remaining water contending fluid back to the membrane system 16 and

FIG. 3b illustrates an embodiment as in FIG. 3a where the membrane system 16 further is configured to be flushed by a back flushing system 34 using a flushing agent 32.

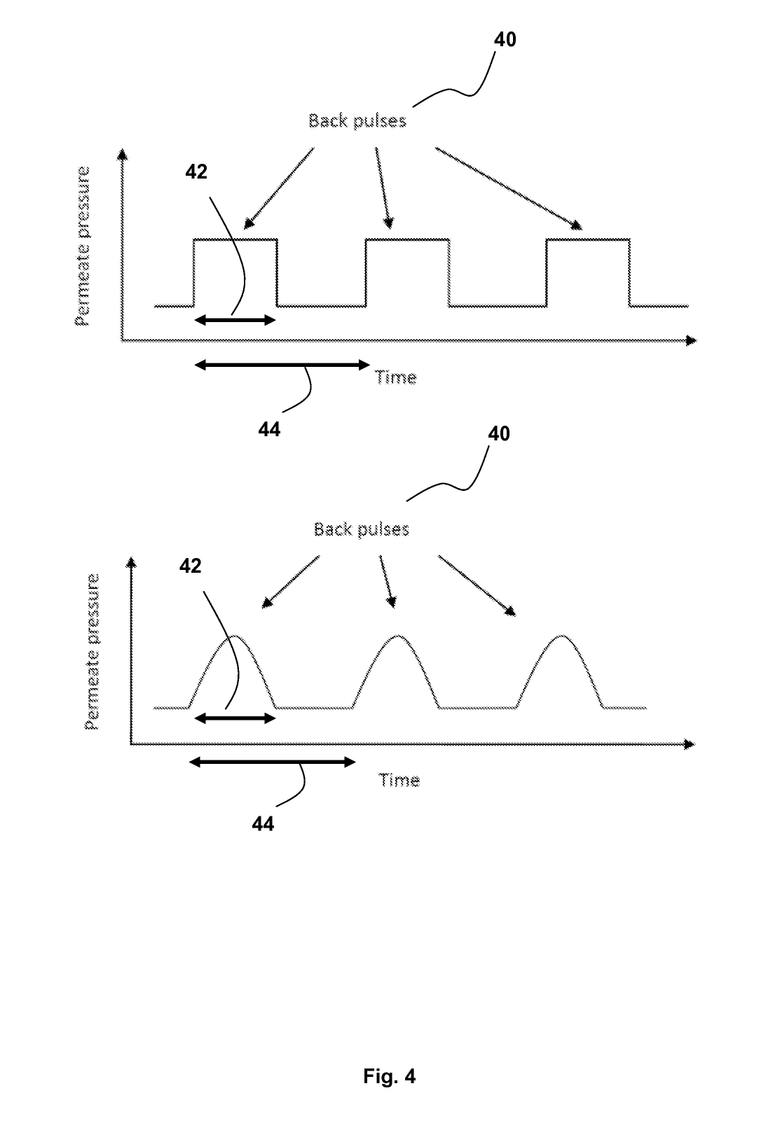

FIG. 4 illustrates back pulses 40 that the back flushing system 34 is configured to generate. Each back pulse 40 has a pulse width 42 and a pulse period 44.

FIG. 4a illustrates back pulses 40 that are formed as squares and FIG. 4b back pulses 40 that are smoother.

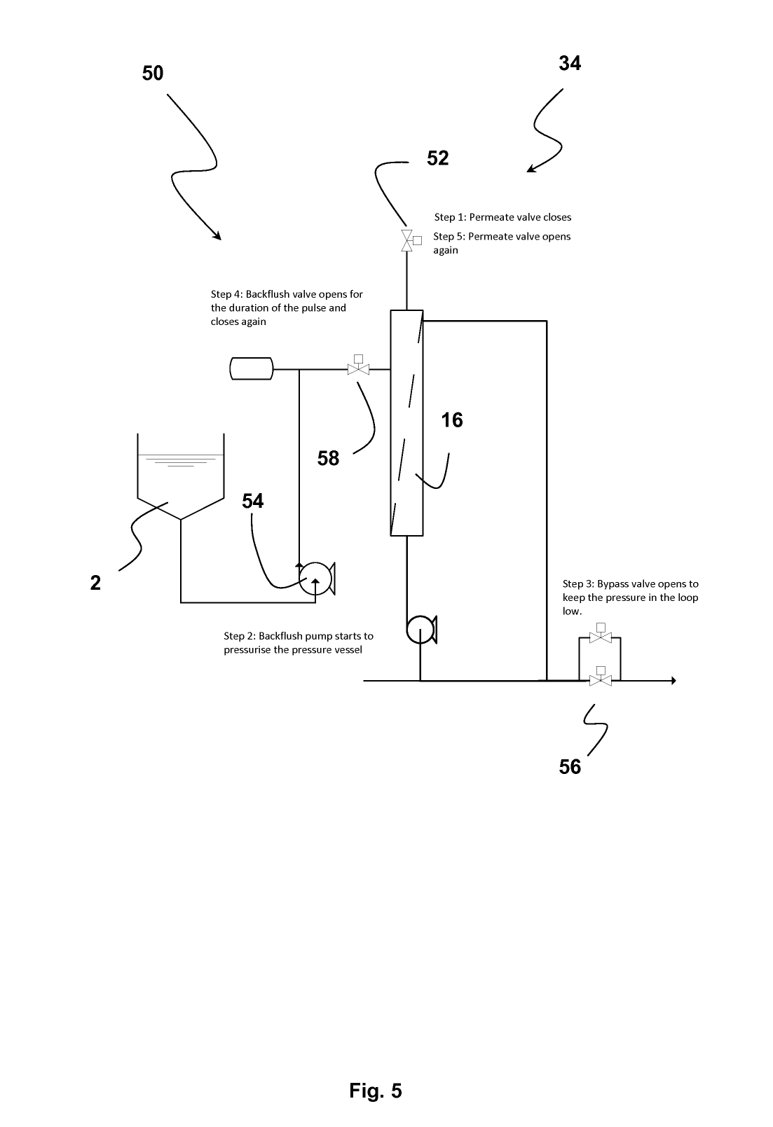

FIG. 5 illustrates a procedure for back flushing 50. The procedure may be used for the different embodiments described and generally relates to an implementation of a back flush system 34.

Generally it is understood that a person skilled in the art will know which type of conduits or pipes to use and which valves and pumps to use. The below description is therefore a guide to an implementation that will realise the described steps in the procedure of back flushing 50 with references to the previous disclosed systems.

There is a first step during which a permeate valve 52 closes. There is a second step where a back flush pump 54 starts to pressurise the pressure vessel. There is a third step where a bypass valve 56 opens to maintain the pressure low in the loop. There is a fourth step where a back flush valve opens for the duration of the pulse width 43 of a back pulse 40 and closes again. There is a fifth step where the permeate valve 52 opens again. The time between the closing and reopening of the permeate valve 52 in step one and step five essentially defines the pulse period 44.

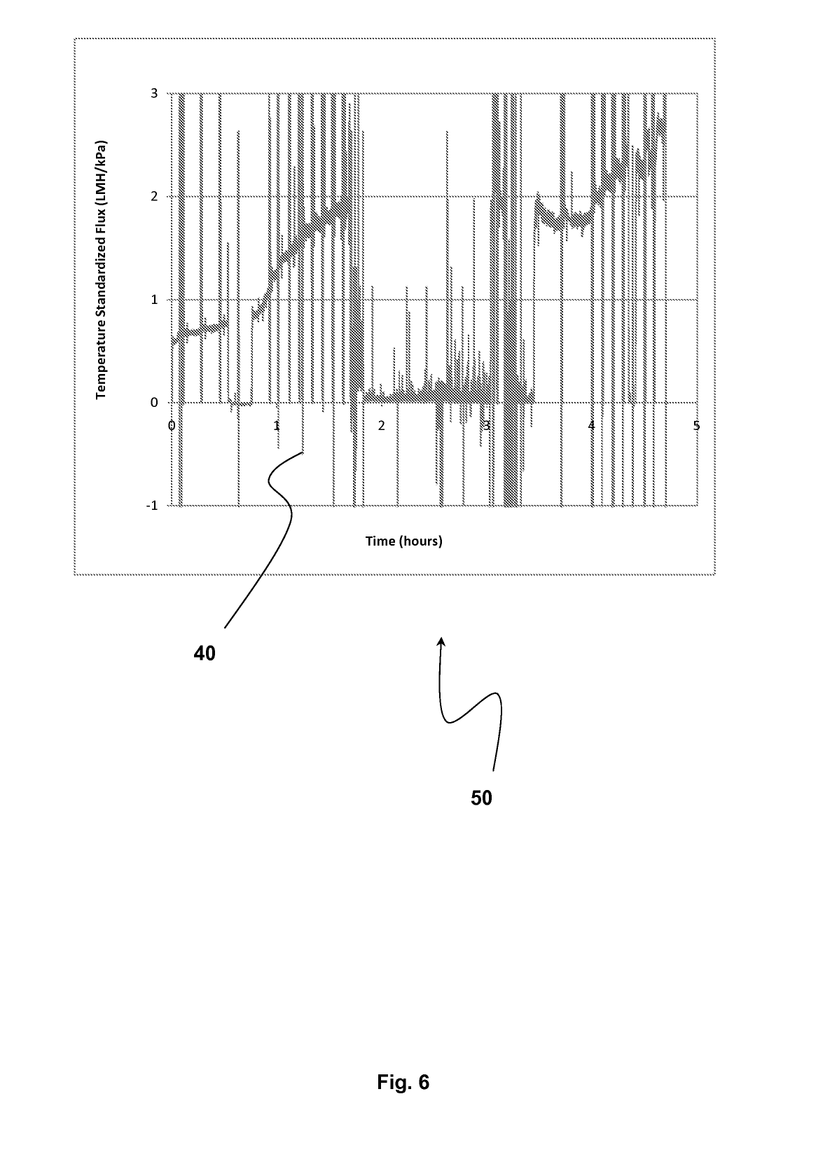

FIG. 6 illustrates a temperature standardised flux through a membrane system installed with ceramic membrane during a clearing procedure of the membrane system.

The temperature standardised flux shows the effect of a back flushing 50.

In order to clean the system a cleaning procedure was initiated, with a water flush, a flush with a membrane detergent and a flush with the alkaline detergent with the composition mentioned earlier.

The initial water flush was performed for about ½ hrs resulting in a small increase in flux from 0.5 to 0.7 LMH/kPa.

A flux level of about 0.7-0.8 LMH/kPa is seen until about 1 hrs. Between 1 to 2 hrs a back flushing 50 using an acid flushing agent, a citric acid, is observed to improve the flux rate to about 2 LMH/kPa with a noticeable flux increase from 0.7 to 1.5 LMH/KPA followed by a period where the effects of the acid back flushing diminishes. The citric acid solution was an approximate 1% w/w solution at a pH of 2-3.

The oil-water separating virtually clogs at about 2 hrs taking the flow to about zero and an alkaline wash, a mixture of some percents of a sodium hydroxide, an anionic surfactant, a citric acid, a sodium carbonate dissolved in alcohols, which is not within the composition of the disclosed flushing agent is performed for 1.5 hrs until about 3.5 hrs after the acid wash. At about 3 hrs, the permeate valve was opened to allow filtration with alkaline wash. There was no noticeable flux increase observed. The alkaline wash solution was approximately 1-2% w/w at a pH of 7.

At about 3.5 hrs and for about 1 hrs a cleaning procedure using a cleaning agent branded as Solution 100 provided by the applicant, which has a composition within the preferred range was used as a flushing agent, was performed and an increase in flux from 1.5 to 2.2 LMH/kPA was observed. The Solution 100 was approximately 1-2% w/w at a pH of 8-9.

The oil-water separation system membrane system recovers its flux at about 3.5 hrs at a flux level of about 2 LMH/kPa.

A final flush with water was performed for about ½ hrs after 4.5 hrs of operation. The flux still continued to increase during this time to about 2.3 LMH/kPa.

The system may have still have contained a branded Solution 100 by the applicant and more water was added to the system during the flush and the system was neutral at the end.

The system was seen to have obtained 99% of the water flux measured with a clean system.

Hence flushing using back-flushing improves the flux of the membrane system and thus the oil-water separation system.

Although particular embodiments have been shown and described, it will be understood that they are not intended to limit the claimed inventions, and it will be obvious to those skilled in the art that various changes and modifications may be made without department from the spirit and scope of the claimed inventions. The specification and drawings are, accordingly, to be regarded in an illustrative rather than restrictive sense. The claimed inventions are intended to cover alternatives, modifications, and equivalents.

1. A system of separating oil and water from produced or fracturing water with an intended separation direction, the system comprising:
a unit for feeding the produced or fracturing water to a solid-fluid separator;
a membrane system configured to output clean water; and
a decanter configured to output solids, wherein the decanter or the membrane system is coupled to an output of the solid-fluid separator;
wherein the membrane system or the decanter is configured to feed remaining fluid from the membrane system or decanter to an oil extractor system configured to output oil; and
wherein the oil extractor system comprises a high speed separator configured to output the oil, and has a feedback conduit for feeding a remaining water containing fluid back to the membrane system.

2. The system according to claim 1, wherein the membrane system is coupled to a flushing system or a backward flush system.

3. The system according to claim 2, wherein the flushing system or the backward flush system is configured to flush or back-flush with a flushing agent.

4. The system according to claim 2, wherein the flushing or the backward flush system is configured to flush with pulses, or back-flush with back-pulses.

5. The system according to claim 1, wherein the membrane system is a ceramic membrane system.

6. The system according to claim 1, wherein the solid-fluid separator comprises a hydro cyclone.

7. The system according to claim 1, wherein the decanter is configured to feed a liquid fraction to the membrane system.

8. The system according to claim 1, wherein the membrane system, not the decanter, is configured to feed the remaining fluid to the oil extractor system, and wherein the oil extractor system comprises a centrifuge configured to output the oil.

9. The system according to claim 1, wherein the membrane system is configured to be flushed by a back flushing system using a flushing agent, wherein the back flushing system comprises:
a back flush pump configured to provide pressure;
a back flush valve configured to regulate the provided pressure in the membrane system for a given period of time; and
a permeate valve configured to equalise pressure in the membrane system.

10. The system according to claim 9, further comprising a flushing controller configured to operate the backward flushing system periodically using a flushing sequence.

11. The system according to claim 10, wherein the backward flushing system is configured to produce a flushing sequence with pulses of variable pressures, variable pulse width, and/or variable pulse period.

12. A method of separating oil and water from produced or fracturing water comprising:
providing a system comprising:
a unit for feeding the produced or fracturing water to a solid-fluid separator;
a membrane system configured to output clean water; and
a decanter configured to output solids, wherein the decanter or the membrane system is coupled to an output of the solid-fluid separator;
wherein the membrane system or the decanter is configured to feed remaining fluid from the membrane system or decanter to an oil extractor system configured to output oil;
wherein the oil extractor system comprises a high speed separator configured to output the oil, and has a feedback conduit for feeding a remaining water containing fluid back to the membrane system; and
wherein the membrane system is coupled to a flushing system or a backward flush system; and
using the system to separate oil and water from the produced or fracturing water.

13. The method of claim 12, further comprising periodically flushing or back flushing the membrane system using the flushing system or the backward flush system.

14. The method of claim 13, wherein the act of periodically flushing or back flushing is performed using pulses or back pulses.

15. The method of claim 14, wherein each of the pulses or each of the back pulses is performed between 1 ms and 10 s.

16. The method of claim 14, wherein each of the pulses or each of the back pulses is performed every 1 min to 10 min.

17. The method of claim 12, wherein the flushing system or the backward flush system uses flushing fluid, and the method further comprises adding a flushing agent to the flushing fluid.

18. The method of claim 17, wherein the flushing agent comprises no more than a total of 100% of:
between 5 to 70% w/w Sodium Carbonate;
between 1 to 20% w/w Disodium Metasilicate;
between 1 to 20% w/w Sodium Percarbonate;
between 1 to 20% w/w Sodium Silicate; and
between 0.1 to 15% w/w of a Fatty Alcohol Alkoxylate.

19. The method of claim 17, wherein the flushing agent comprises no more than a total of 100% of:
between 0.1 to 20% w/w Citric acid;
between 0.1 to 10% w/w Glycolic acid;
between 1 to 20% w/w Lactic acid; and
between 0.1% w/w to 10% w/w Surfactant.

20. The method of claim 17, wherein the flushing agent comprises no more than a total of 100% of between 0.1 to 10% w/w Sodium Silicate and mixed with:
between 1 to 20% w/w Sodium percarbonate;
between 5 to 40% w/w Sodium silicate; and
between 5 to 40% w/w Sodium carbonate.

21. The method of claim 17, further comprising circulating the flushing agent in the system for no less than 20 s.

22. The method of claim 12, further comprising restarting the system when the membrane system is clogged.
